(19) United States
(12) Patent Application Publication
(10) Pub. No.: US 2015/0199641 A1
(43) Pub. Date: Jul. 16, 2015

(54) Labor Distribution Management Using Dynamic State Indicators

(71) Applicant: Intelligrated Headquarters LLC, Mason, OH (US)

(72) Inventor: Daniel Raymond Napoli, Bedford Corners, NY (US)

(73) Assignee: Intelligrated Headquarters LLC, Mason, OH (US)

(21) Appl. No.: 14/186,117

(22) Filed: Feb. 21, 2014

Related U.S. Application Data
(60) Provisional application No. 61/928,199, filed on Jan. 16, 2014.

(51) Int. Cl. G06Q 10/06

(52) U.S. Cl. CPC G06Q 10/063114

(57) ABSTRACT

Systems, methods, devices, and non-transitory processor-readable storage media enabling the characterization of the current states of labor distribution and improved labor distribution management within distribution centers. In an embodiment, a computing device may be configured to analyze data related to the workloads of various tasks performed in a distribution center as well as data related to labor to determine state information that represent whether the tasks are adequately staffed for a given time and generate and/or display graphical information related to the adequacy of labor distribution for the various tasks of the distribution center. The computing device may assign state indicators that code, rank, or otherwise characterize the current labor distribution for tasks. The computing device may re-assign workers to various tasks performed within a distribution center by transmitting messages that re-assign a worker to a new zone and/or task.

### CROSS REFERENCE TO RELATED APPLICATIONS

This application claims the benefit of priority to U.S. Provisional Patent Application No. 61/928,199 entitled “Labor Distribution Management Using Dynamic State Indicators” filed Jan. 16, 2014, the entire contents of which are hereby incorporated by reference.

### BACKGROUND

Distribution centers often handle inventory for supporting large customer bases across large geographic areas. Such distribution centers may include numerous zones that each may correspond to one or more tasks performed by workers in each zone. For example, a distribution center may include several zones that are associated with a picking or pick task, each having various workers assigned to perform item picking tasks, item put away tasks, and indirect supporting tasks. Personnel occurrences (e.g., worker absences due to illness or vacation), abrupt changes in distribution center workload (e.g., receipt of unexpected volume orders) and/or equipment problems (e.g., sorter or belt failures in the distribution center), may cause distribution centers to experience periods when the labor assigned to particular zones or tasks within zones is inadequate for fulfilling orders in a timely manner. Thus, labor distribution is a primary concern for maintaining efficiency within distribution centers. Current labor management systems may require significant time and manual user interaction to detect such inadequate labor distributions and identify appropriate solutions.

### SUMMARY

The various embodiments provide systems, methods, devices, and non-transitory processor-readable storage media enabling the characterization of the current states of labor within distribution centers and improved labor distribution management within distribution centers. In an embodiment, a computing device may be configured to analyze data related to the workloads of various tasks performed in a distribution center as well as data related to labor (or workers) to determine state information (or states) that represent whether the tasks are adequately staffed for a given time and generate and/or display graphical information related to the adequacy of labor distribution of the various tasks performed in the distribution center. In an embodiment, the computing device may assign state indicators that code, rank, or otherwise characterize the current labor distribution for tasks. In an embodiment, the computing device may be configured to re-assign workers to various tasks associated with zones in a distribution center by transmitting messages that re-assign a worker to a new zone and/or task.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system block diagram of a network suitable for use with the various embodiments.

FIG. 2A is an embodiment graphical display indicating state information corresponding to tasks within a distribution center.

FIG. 2B illustrates the embodiment graphical display of FIG. 2A at a later time than illustrated in FIG. 2A.

FIGS. 3A-3D are diagrams illustrating various graphical interfaces used to display labor information related to tasks performed within a distribution center.

FIG. 4 is a process flow diagram illustrating an embodiment method for determining states of tasks performed within a distribution center based on workloads and worker assignments.

FIG. 5 is a process flow diagram illustrating an embodiment method for re-assigning workers to tasks performed within a distribution center.

FIG. 6 is a component diagram of an example laptop computing device suitable for use with the various embodiments.

FIG. 7 is a component block diagram of an example wireless computing device suitable for use in various embodiments.

FIG. 8 is a component block diagram of a server computing device suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “computing device” is used herein to refer to any one or all of desktop computers, cellular telephones, smart phones, personal or mobile multi-media players, personal data assistants (PDA's), laptop computers, tablet computers, smart books, retail terminals, palm-top computers, wireless electronic mail receivers, wireless mobile headset devices, multimedia Internet enabled cellular telephones, wireless gaming controllers, and similar electronic devices which include a programmable processor and memory and circuitry for performing operations discussed herein, including establishing network connections, receiving user input, and rendering data.

The various embodiments are described herein using the term “server.” The term “server” is used to refer to any computing device capable of functioning as a server, such as a master exchange server, web server, mail server, document server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

The various embodiments provide systems, methods, devices, and non-transitory processor-readable storage media for enabling improved labor distribution management within distribution centers. In particular, a computing device may be configured to analyze data related to the workloads of various tasks performed within a distribution center as well as data related to labor (or workers) associated with the distribution center. Based on this analysis, the computing device may determine state information (or states) that represent whether the various tasks are adequately staffed for a given time. For example, the computing device may analyze data of open fulfillment orders for a certain shift (e.g., day shift, etc.) received from a demand scheduler to estimate the number of workers needed in a pick task within a designated picking area and may compare the estimated number to the number of workers currently assigned to pick tasks in the picking area for the shift to determine whether the pick task has an adequate amount of workers assigned. The computing device may calculate the state of the tasks performed within the distribution center continually and/or periodically, and thus may generate dynamic labor distribution information reflecting the current state of the tasks within the distribution center. In an embodiment, the computing device may determine states (and state indicators) for groupings of tasks, such as a state for a plurality of tasks of a zone of a distribution center or a state for a plurality of tasks of a certain type (or task type). The various embodiments may enable labor management personnel of a distribution center to access data that efficiently identifies where workers should be distributed to avoid decreases in productivity.

In an embodiment, the computing device may be configured to generate and/or display graphical information related to the adequacy of labor distribution for tasks in various zones of a distribution center. In particular, the computing device may assign indicators (or state indicators) that code, rank, or otherwise characterize the current labor distribution of tasks in zones. For example, a first task may be determined to be well staffed with workers for a time period and thus may be associated with a “Green” state indicator, while another task may be determined to be under staffed below an acceptable threshold for longer than a set period of time and thus may be associated with a “Red” state indicator that pulses (e.g., flashes red). The computing device may be configured to render state indicators via graphical interfaces, such as images, pictograms, or elements rendered in association with an application (e.g., a browser displaying a webpage, rendering software on a monitor, an app on a laptop, etc.). By providing graphical representations of state indicators, the computing device may enable users to quickly monitor graphical interfaces to confirm the correctness of current labor distributions and monitor for special conditions that may require worker re-assignments. In another embodiment, the computing device may be configured to render data related to individual workers within the distribution center, such as personnel data and/or tasks the worker is trained or certified to perform.

In an embodiment, the computing device may be configured to re-assign workers to various tasks in a distribution center. In response to receiving selection input, such as a touchscreen input on a graphical user interface button (e.g., a “re-assign” button), the computing device may perform operations to adjust stored data and/or transmit messages that re-assign a worker to a new zone and/or task. In response to performing operations for re-assigning workers, the computing device may be configured to transmit messages to various devices indicating the re-assignments, such as by sending emails, SMS text messages, and other communications to devices used by management personnel, individual workers, and/or display units visible to workers within the distribution center.

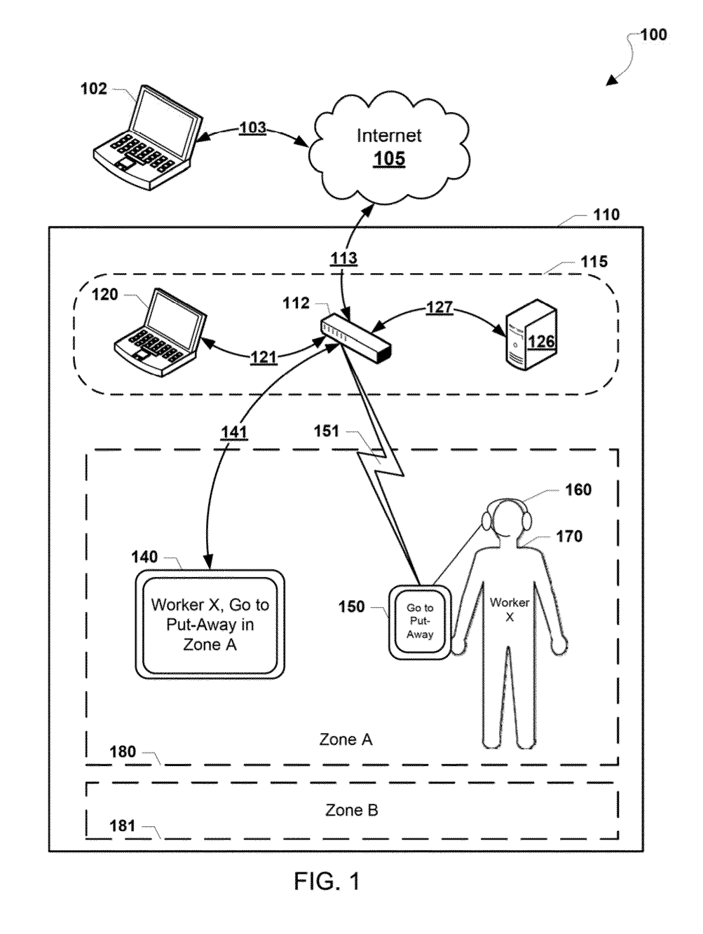

FIG. 1 illustrates an embodiment system 100 that includes various computing devices within a distribution center 110. The distribution center 110 may be any facility that utilizes labor to process inventory. For example, the distribution center 110 may be a distribution center for a retailer, shipping entity, or other organization that has an inventory system for receiving, storing, transporting, and/or shipping items (e.g., packages, parts, etc.). The distribution center 110 may be divided into a plurality of zones, such as Zone A 180 and Zone B 181 which may be areas within the distribution center 110. While illustrated as having two zones, Zone A 180 and Zone B 181, the distribution center 110 may include less zones, such as only a single zone, or more zones, such as three or more zones.

Zone A 180 may be a certain area in the center of the distribution center 110, such as a picking area, loading dock, a sorting area, etc. Laborers, such as a Worker X 170 may work within the distribution center 110 and further may be assigned to various tasks, teams, details, or jobs within a zone, such as Zone A 180 or Zone B 181. For example, Zone A may be a picking area and Worker X 170 may be assigned perform a picking task, put away task, or indirect supporting task in Zone A 180. A plurality of tasks may be associated with an individual zone, and thus the Worker X 170 may re-assigned (or re-directed) to different tasks within the Zone A 180. For example, at a first time of day, Worker X 170 may be assigned to perform a picking task (e.g., selecting items for placement in cartons for shipment out of the distribution center) in the Zone A 180, but at a second time of day Worker X 170 may be re-assigned to a put-away task (e.g., replacing items on stock shelves) within the Zone A 180. Additionally, Worker X 170 may be re-assigned to the same or different tasks in a different zone, such as Zone B 181. For example, at a first time of day, Worker X 170 may be assigned to perform a picking task in the Zone A 180, and at a second time of day, Worker X 170 may be re-assigned to perform a picking task in Zone B 181. Workers in the distribution center 110, such as Worker X, may be certified to perform tasks on a per task basis and/or a per zone basis, and the tasks and/or zones a worker is assigned to may be based on that worker's certifications.

The distribution center 110 may include a router 112 (e.g., a Wi-Fi router) that utilizes a connection to the Internet 113 and that is associated with a local area network 115, as well as a server 126 that may be connected to the router 112 via a wireless or wired connection 127. The server 126 may be configured with server-executable instructions perform operations to manage and/or store various information related to the distribution center 110, such as worker schedules, workers certifications, workloads, inventory data, orders, shipping information, historical data (e.g., annual workload data, etc.), personnel records, and/or other data. The server 126 may further include various data tables, structures, and databases and/or be coupled to data storage devices that organize and store the various data. For example, the server 126 may be configured to perform operations to identify worker names, certifications, and work schedules for a period (e.g., a weekly shift schedule, etc.), as well as operations to identify trends in distribution center workloads, such as zones or tasks with the highest workload demands for a time of day, week, and/or year. The server 126 may be configured to communicate with various devices via Internet protocols, such as by transmitting emails, SMS/MMS text messages, or other messaging protocols over the Internet 105.

Additionally, the server 126 may be configured to communicate with various devices associated with the distribution center 110 and/or the local area network 115. In particular, the server 126 may transmit messages, such as communications that indicate worker assignments (or re-assignments), to the router 112 for delivery to a display unit 140 (e.g., a monitor, etc.) via a wired or wireless connection 141. For example, the server 126 may transmit a message (e.g., “Worker X, go to put-away in Zone A.”) for rendering on the display unit 140 so that nearby workers may be notified of task re-assignments. In an embodiment, the server 126 may be configured to also transmit messages to wireless devices carried by workers and capable of exchanging data over the local area network 115 via a wireless link 151, such as a wireless computing device 150 connected to a head set 160 worn by Worker X 170. For example, in response to identifying that the current task assignment of Work X 170 has been changed from a pick task to a put-away task in the Zone A 180, the server 126 may be configured to transmit a notification message, such as “Go to Put-away” to the wireless computing device 150 associated with Worker 170 for display on a screen of the wireless computing device 150 and/or for audible output via the head set 160 worn by Worker X and connected to the wireless computing device 150.

In an embodiment, a laptop computing device 120 may also be within the distribution center 110 and may utilize a connection 121 to the router 112 to exchange communications with the server 126 and various other devices. For example, the laptop computing device 120 may be configured to receive from the server 126 activity information of the distribution center (e.g., current workload in various zones, items to process within Zone A 180 over a certain period, number of workers needed for a certain shift of a task in a zone, etc.) and/or worker status information (e.g., timesheets, personnel records, weekly task schedule, etc.). In an embodiment, the laptop computing device 120 may be configured to access the server 126 to execute various operations, software, applications, and routines remotely (e.g., run a batch job, access a database, etc.).

In an embodiment, a remote computing device 102 with a connection 103 to the Internet 105 may exchange communications with the various devices associated with the distribution center 110. For example, the remote computing device 102 may receive data indicating current task assignments for workers of the distribution center from the server 126, and in response to receiving user inputs, may transmit updated assignment data (or reassignments) to the server 126 and/or the wireless computing device 150 of the worker 170. In other words, the remote computing device 102 may perform operations similar to those performed by the laptop computing device 120 within the distribution center 110.

In an embodiment, various computing devices, such as the laptop computing device 120 and/or the remote computing device 102, may access the server 126 via a web portal or website interface. For example, the laptop computing device 120 may access database information managed by the server 126 via a web page administered by the server 126.

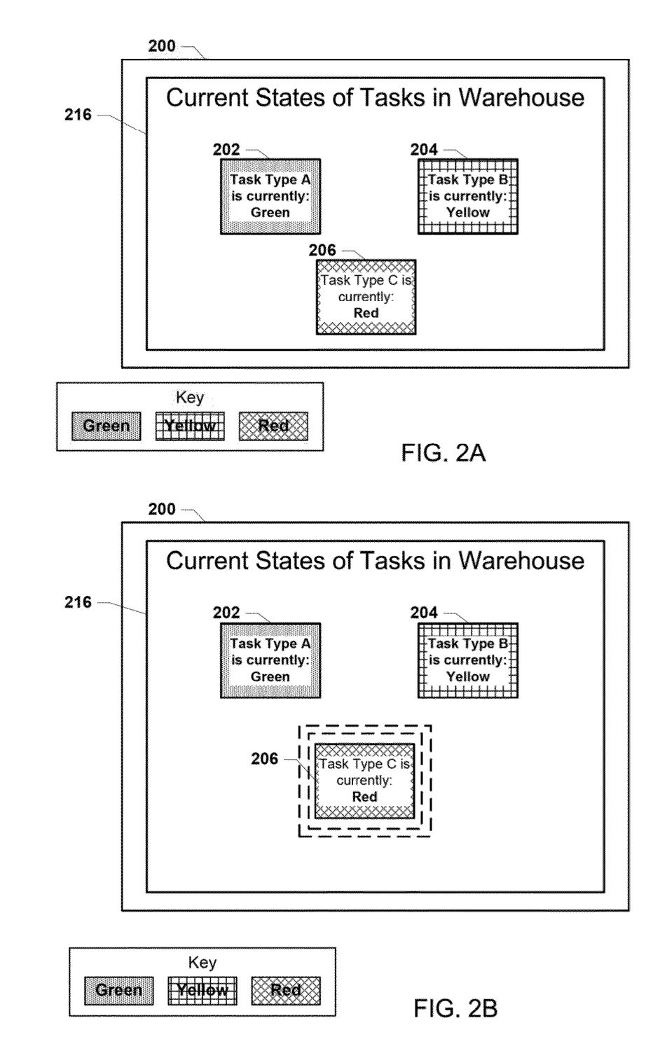

FIGS. 2A-2B show an embodiment graphical interface 216 rendered on a display 200 of a computing device that indicates state information corresponding to tasks performed within a distribution center at an initial time. In various embodiments, the computing device may be a server, a wireless computing device worn or carried by a worker, a laptop, or any other computing device configured to obtain and display data related to the labor distribution in a distribution center. Further, data displayed via the graphical interface 216 may be obtained locally by the computing device, such as via a coupled database or storage device, and/or received from a remote device, such as a server or web server.

As described above, a distribution center may be divided into various zones (e.g., Zone A, Zone B, etc.). Each zone may be associated with various tasks that may be categorized (or summarized) in general types (or task types). For example, a Pick task type may include different types of picking-related tasks, such as a Cluster Pick task, a Discrete Pick, etc. It should be appreciated that tasks types may be used to categorize tasks performed within the distribution center, however other hierarchies or organizations may also be used. For example, in another embodiment, tasks (e.g., cluster pick, discrete pick, audit, etc.) may be categorized and/or summarized by the zone or area (e.g., Zone A, Zone B, etc.) in which the tasks are performed.

Each task performed within the distribution center may be dynamically prioritized, rated, or otherwise characterized based on the amount of work (or workload) being experienced for a particular task compared to the labor available for that task. Such a characterization may be referred to as the “state” of a task. For example, a current state of a task may be adequately staffed, overstaffed, or understaffed. As another example, the state for a first task performed within a distribution center during a day shift may represent how adequately staffed the first task is with laborers with regard to the number of packages to be distributed during an average day shift. States may characterize the adequacy of staffing or labor for various time periods, such as a shift (e.g., day shift, night shift, morning shift, etc.), a time of day (e.g., in the morning, from 4:00 PM-5:00 PM, etc.), a day of the week, a week, a month, a time related to an event (e.g., a period after inventory to be delivered is received from an originating party, a period prior to a scheduled delivery, etc.), etc.

As noted above, in various embodiments, a processor of a computing device may determine states (and assign state indicators) for groupings of tasks, such as by determining a state for task types (e.g., Pick, etc.), zones within the distribution center, and/or any other logical grouping of individual tasks. In particular, states for tasks types or zones that may include more than individual task (i.e., a plurality of tasks) may be assigned a state that is a summary, average, or other estimation of the states of the individual tasks included within such a grouping. For example, a state for a task type (e.g., Pick) may be the average rank of all the specific or individual tasks (e.g., Cluster Pick, Discrete Pick, etc.) of that task type. As another example, a state for a zone (e.g., Zone A, etc.) may be the average rank of all the tasks performed within that zone. Various schemes or techniques may be used for assigning a state to a task type or a zone based on individual task states, such as taking an average, a minimum state, a maximum state, etc. As an illustration: a computing device may identify a plurality of tasks of a first type (or task type) based on the activity information of a distribution center, identify a current workload for the plurality of tasks of the first type (e.g., a combined workload, etc.) based on the activity information of the distribution center, identify a plurality of individual workers currently assigned to one of the plurality of tasks of the first type based on the status information of the workers of the distribution center, and compare the identified current workload for the plurality of tasks of the first type with the identified plurality of individual workers currently assigned to one of the plurality of tasks of the first type to determine an adequacy of labor for the plurality of tasks of the first type and corresponding state of the plurality of tasks of the first type.

States may be associated with state indicators that describe the condition of the tasks or logical grouping of tasks (e.g., task type, zone, etc.). For example, states may be indicated by colors, such as “green,” “yellow,” or “red.” “Green” may be an indication of a beneficial or adequate state, “yellow” may be an indication of a neutral or marginally adequate state, and “red” may be an indication of a negative or inadequate state. As an additional example, a current state of a task may be indicated by text labels reflecting the color of the state indicator describing the current condition of the task.

In an embodiment, graphical elements or indicators of the states of tasks performed within a distribution center may be rendered via the graphical interface 216. As shown in FIG. 2A, the graphical interface 216 may include a first graphical element 202 that indicates a first state of a first task type (i.e., “Green” for Task Type A), a second graphical element 204 that indicates a second state for a second task type (i.e., “Yellow” for Task Type B), and a third graphical element 206 that indicates a third state for a third task type (i.e., “Red” for Zone C). In an embodiment, the graphical elements 202-206 may be interactive, such as graphical user interface (GUI) button items that may configured to cause the computing device to perform operations, routines, and/or execute other instructions in response to being highlighted, selected, tapped, clicked, etc. For example, the first graphical element 202 may be linked to a webpage uniform resource locator (URL) that may be visited via a browser application, an application that may be launched, or a script that may be executed by the computing device when a user taps on a section of a touchscreen corresponding to the area of the first graphical element 202. As another example, the second graphical element 204 may be configured to cause the computing device to obtain and render more detailed information about the Zone B when selected (e.g., clicked via a mouse cursor).

In an embodiment, the graphical interface 216 may be a dashboard, such as a notification application executing on a computing device. For example, the graphical interface 216 may be rendered within a window, tile, or section of a screen or foreground of labor management application running on a computing device used by a labor manager of a distribution center.

In the embodiment illustrated in FIG. 2A, the tasks of Task Type A may be considered to be adequately staffed with workers, the tasks of Task Type B may be considered to be marginally-adequately staffed with workers, and the tasks of Task Type C may be considered to be inadequately staffed with workers. For example, the Task Type A may currently have the recommended number of laborers working to complete the current workload for all the individual tasks included within the Task Type C category in an optimal manner. Because Task Type A currently has the recommended number of laborers to complete the current workload for its included individual tasks, the graphical element 202 for Task Type A may be colored green. Task Type B may currently have a number of laborers that is within an acceptable threshold of a recommended number based on the current workload for the tasks of Task Type B. Because Task Type B does not have optimal labor but is within the acceptable threshold, the graphical element 204 for Task Type B may be colored yellow. Task Type C may currently have a number of laborers that is outside (or below) an acceptable threshold of a recommended number based on the current workload for the individual tasks of Task Type C. Because Task Type C is staffed below the acceptable threshold, the graphical element 206 of Task Type C may be colored red. In an embodiment, the acceptable threshold and/or optimal conditions for a task (or task type or zone) may be set based on user configurable settings, such as settings controlled by the distribution center manager. With the display of graphical elements 202-206, users of the computing device easily may become aware of task types that may require labor re-assignments (e.g., switch workers from one task to another, move workers to another zone, idle workers, etc.).

FIG. 2B shows the embodiment graphical interface 216 rendered on the display 200 of the computing device at a time subsequent to the initial time in FIG. 2A that indicates state information corresponding to Task Types A, B, and C within the distribution center. At the later time illustrated in FIG. 2B, the labor condition for the tasks of Task Type C may have remained below the acceptable threshold for longer than a set period of time. Because the length of time the labor condition remained below the acceptable threshold for the tasks of Task Type C exceeded the set period of time, the graphical element 206 for Task Type C may begin to flash as indicated by the dashed lines in FIG. 2B. In other words, the graphical element 206 may be rendered so that it appears to be “pulsing.” As examples, the graphical element 206 for Task Type C may be periodically rendered by the computing device so that the color, brightness, luminosity, contrast, size, and/or pattern of the graphical element 206 changes from a first setting to a second setting and back to the first setting over a predefined duration. For example, the graphical element 206 may be rendered to pulse in size or to appear as a blinking image in response to the computing device determining that the tasks of Task Type C have had fewer than the recommended number of workers for longer than a predefined time period. As another example, the graphical element 206 may be rendered to flash in brightness when the tasks of Task Type C have no assigned workers. The computing device may render the graphical element 206 in various pulse intensities or formatting based on pulse information or pulse values associated with the corresponding task type. For example, the less adequate the current labor distribution for the tasks of Task Type C is, the faster and/or brighter the computing device may render the graphical element 206.

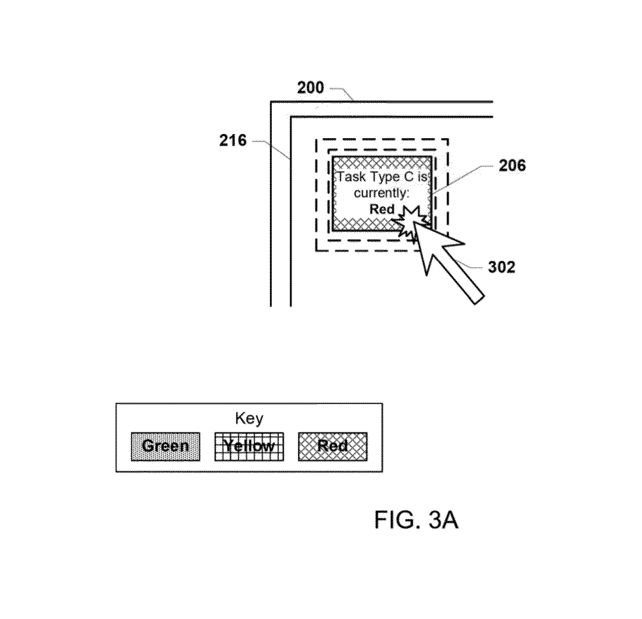

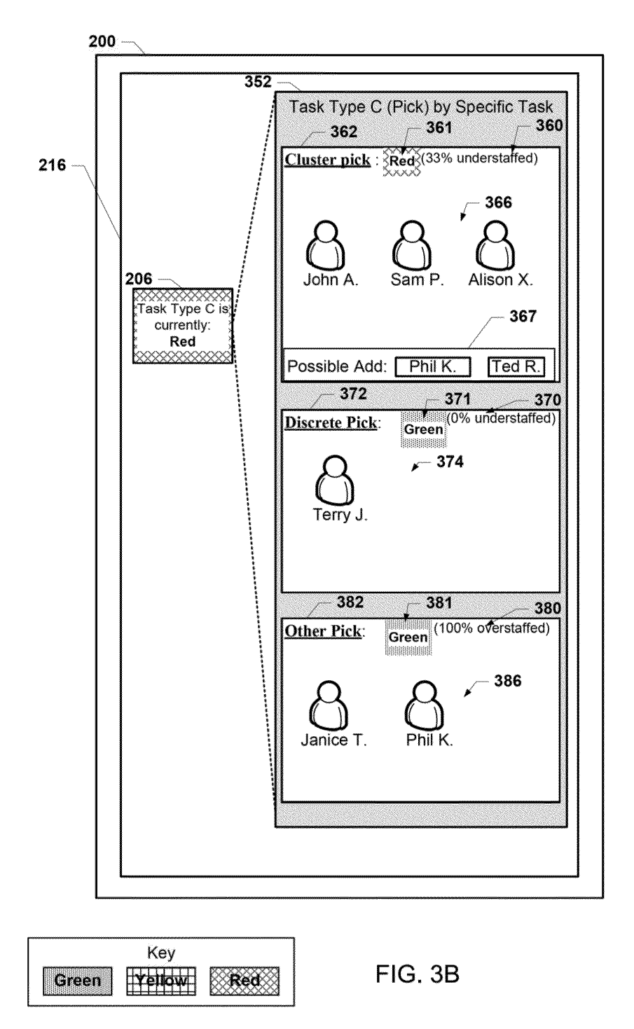

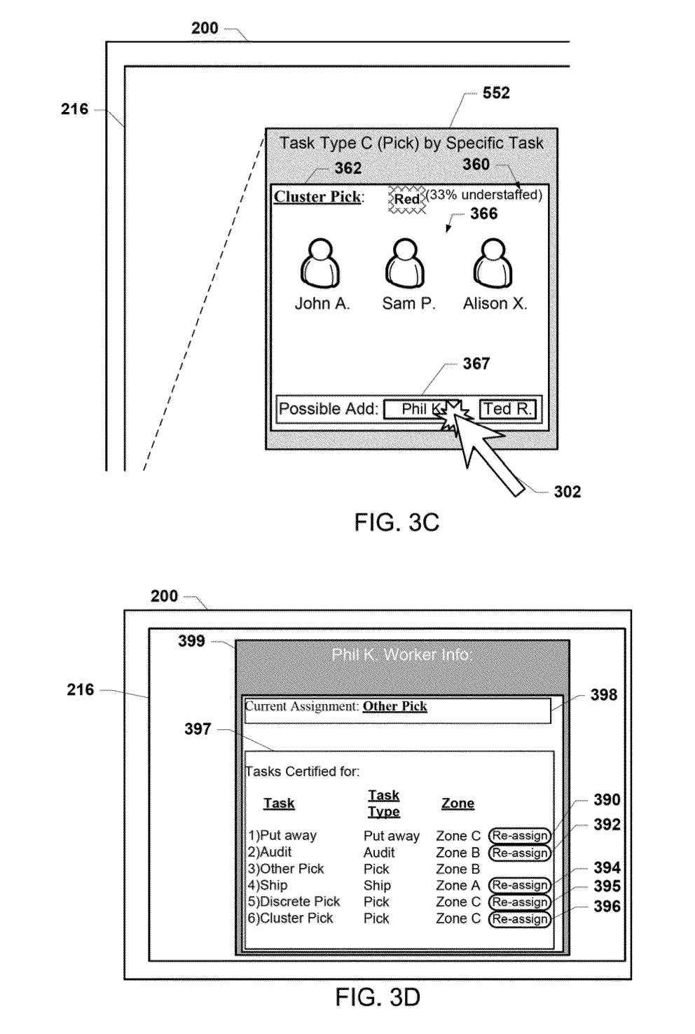

FIGS. 3A-3D show portions of the embodiment graphical interface 216 rendered on the display 200 of the computing device that indicates labor distribution information corresponding to tasks of a particular task type (e.g., Pick) performed within a distribution center. In various embodiments, the computing device may be a server, a wireless computing device worn or carried by a worker, a laptop, or any other computing device configured to obtain and display data related to the labor distribution in a distribution center. Further, the labor distribution information and other data displayed via the graphical interface 216 may be obtained locally by the computing device, such as via a coupled database or storage device, and/or received from a remote device, such as a server or web server.

As described above with reference to FIGS. 2A-2B and as shown in FIGS. 3A-3D, the graphical interface 216 may include graphical elements that indicate the state of each type of task and/or the state of each individual task performed within a distribution center. For example, in FIGS. 3A-3B, a graphical element 206 may indicate an inadequate state corresponding to a Task Type C. As discussed above, in an embodiment, such graphical elements may be interactive, such as a button item within an application executing on the computing device (e.g., a browser, an app, etc.).

FIG. 3A illustrates a portion of the graphical interface 216 and the selection of the graphical element 206 by a cursor element 302 controlled via a mouse or other user input device. For example, the graphical element 206 may be selected when the cursor element 302 is positioned over the graphical element 206 in combination with a user clicking a button on the mouse. It should be appreciated that various other techniques of selecting the graphical element 206 may be implemented with the computing device. For example, when displayed on a touch screen coupled to the computing device, the graphical element 206 may be selected via a user touch input on the area of the screen corresponding to the graphical element 206. The graphical element 206 may be colored red and pulsing indicating that the labor assigned for the tasks of Task Type C is below the acceptable threshold and has been for longer than a set period of time.

In response to the selection of the graphical element 206 depicted in FIG. 3A, the computing device may be configured to render a labor distribution panel 352 within the graphical interface 216, as shown in FIG. 3B. For example, the labor distribution panel 352 may be rendered by the computing device to pop-up or otherwise arise from the selected graphical element 206. The labor distribution panel 352 may include various data and elements that indicate the workers assigned to the various tasks of the task type corresponding to the graphical element 206 (i.e., the specific or individual tasks of Task Type C). The labor distribution panel 352 may include sections associated with each task of the task type corresponding to the graphical element 206. As examples, a cluster pick graphical section 362 may be associated with a specific cluster pick task of Task Type C, a discrete pick graphical section 372 may be associated with a specific discrete pick task of Task Type C, and an ‘other’ pick graphical section 382 may be associated with a specific other pick task of Task Type C. Cluster pick graphical section 362 may include a specific task state indicator 361 (e.g., “Red”), a staffing indication 360 indicating the percentage understaffed or overstaffed (e.g., 33% understaffed) for the cluster pick task, as well as a worker area 366 including icons (e.g., figurines) indicating each worker (e.g., John A, Sam P., and Alison X.) currently assigned to the specific cluster pick task of Task Type C. While illustrated and discussed based on worker tracking by first name and last initial, the various embodiments may track workers by other identifiers or combinations of identifiers, such as worker identification numbers, badge numbers, last name, etc. Discrete pick graphical section 372 may include a specific task state indicator 371 (e.g., “Green”), a staffing indication 370 indicating the percentage understaffed or overstaffed (e.g., 0% understaffed) for the specific discrete pick task, as well as a worker area 374 including icons (e.g., figurines) indicating the worker (e.g., Terry J.) currently assigned to the discrete pick task of Task Type C. Other pick graphical section 382 may include a specific task state indicator 381 (e.g., “Green”), a staffing indication 380 indicating the percentage understaffed or overstaffed (e.g., 100% overstaffed) for the other pick task, as well as a worker area 386 including icons (e.g., figurines) indicating the workers (e.g., Janice T. and Phil K.) currently assigned to the other task of Task Type C.

Cluster pick graphical section 362 may also include a listing 367 of possible additional workers that may be added to the cluster pick task, such as workers Phil K. or Ted R. The listing 367 may indicate workers that are certified to perform the cluster pick task. In an embodiment, the listing 367 may indicate the workers that are certified to perform the cluster pick task for a particular zone. Workers may be workers selected from overstaffed tasks of Task Type C whom are certified to perform the cluster pick task, such as Phil K. who may currently be assigned to the other pick task that is 100% overstaffed, and/or additional or idle workers, such as Ted R., who may not be currently assigned a task but are qualified to perform the cluster pick task.

The icons in the worker areas 366, 374, and 386 and/or the names in the listing 367 of possible additional workers may be interactive elements selectable by a user. Similar to the selection of the graphical element 206 associated with Task Type C described above with reference to FIG. 3A, FIG. 3C illustrates a selection of the interactive element “Phil K.” of the listing 367 of possible additional workers in the cluster pick graphical section 362. For example, the interactive element “Phil K.” may be selected when the cursor element 302 is positioned over the name “Phil K.” in combination with a user clicking a button on the mouse.

In response to the selection of the interactive element depicted in FIG. 3C, the computing device may be configured to render a worker information panel 399 within the graphical interface 216, as shown in FIG. 3D. The worker information panel 399 may include data related to the worker associated with the interactive element “Phil K.”. For example, the worker information panel 399 may include status information, such as personnel data, certifications, credentials, and/or task training information. The worker information panel 399 may include an assignment section 398 that indicates the current task to which the worker is currently assigned (e.g., “Other Pick” task). In an embodiment, the assignment section 398 may also indicate the zone in which the worker is currently assigned (e.g., Zone B, etc.).

The worker information panel 399 may also include a certification section 397 that indicates the tasks, as well as associated task type and zones for each task, for which the worker may be certified. In other words, the training section 397 may indicate all of the various tasks, task type, and zones the worker may possibly be re-assigned to. For example, the certification section 397 may include entries for specific tasks (e.g., Put away, audit, other pick, ship, discrete pick, cluster, pick, etc.) that may each be of different task types (e.g., Put away, Audit, Pick, Ship, etc.) and that may or may not be associated with different zones of the distribution center (e.g., Zone A, Zone, B, Zone, C, etc.). In an embodiment, tasks displayed in the certification section 397 may be associated with graphical user interface (GUI) buttons 390-396 that are linked to various scripts, commands, instructions, or routines that may be performed by the computing device. For example, the certification section 397 may include a first GUI button 390 that when selected (e.g., via a mouse click or touch input) may cause the computing device to perform operations to re-assign the worker to a first task (e.g., Put away) of a first task type (e.g., Put away) in a third zone (e.g., Zone C), a second GUI button 392 that when selected may cause the computing device to perform operations to re-assign the worker to a second task (e.g., audit) of a second task type (e.g., Audit) in a second zone (e.g., Zone B), a third GUI button 394 that when selected may cause the computing device to perform operations to re-assign the worker to a third task (e.g., ship) of a third task type (e.g., Ship) in a first zone (e.g., Zone A), a fourth GUI button 395 that when selected may cause the computing device to perform operations to re-assign the worker to a fourth task (e.g., Discrete Pick) of a fourth task type (e.g., Pick) in the third zone (e.g., Zone C), and a fifth GUI button 396 that when selected may cause the computing device to perform operations to re-assign the worker to a fifth task (e.g., Cluster Pick) of the fourth task type (e.g., Pick) in the third zone (e.g., Zone C). The certification section 397 may not include GUI buttons for tasks the worker is current assigned to perform (e.g., Other Pick task in Zone B).

In an embodiment, in addition to the buttons 390-396, workers may be added or re-assigned to different tasks by dragging the icons (e.g., figurines) for the worker from one worker area 366, 374, or 386 to another worker area 366, 374, or 386. Additionally workers may be added or re-assigned to different tasks by dragging the interactive element represented by the workers name in the listing 367 into a worker area 366, 374, or 386.

In various embodiments, selection of the various GUI buttons 390-396, dragging of the icons (e.g., figurines) to a worker area 366, 374, or 386, and/or dragging of the interactive element represented by the workers name in the listing 367 into a worker area 366, 374, or 386 may cause the computing device to transmit a message to communicate re-assignment requests, such as by transmitting an email or SMS text message to the personal device (e.g., wireless computing device with connected headphones) of the corresponding worker to be re-assigned, a device used by labor management personnel (e.g., a laptop within an administrative office), a display unit (e.g., a monitor within a zone of the distribution center), and/or a server configured to maintain data for personnel and assignments. In this manner, workers may be efficiently and easily re-assigned to new tasks to address current labor distribution issues for various tasks of various task types or performed within various zones of a distribution center.

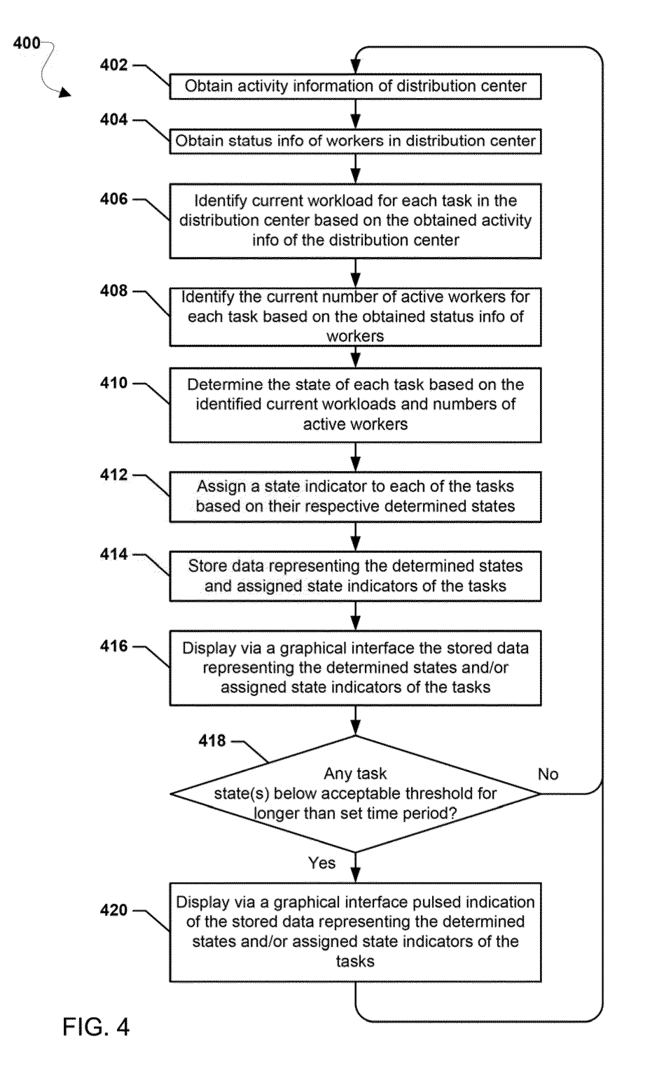

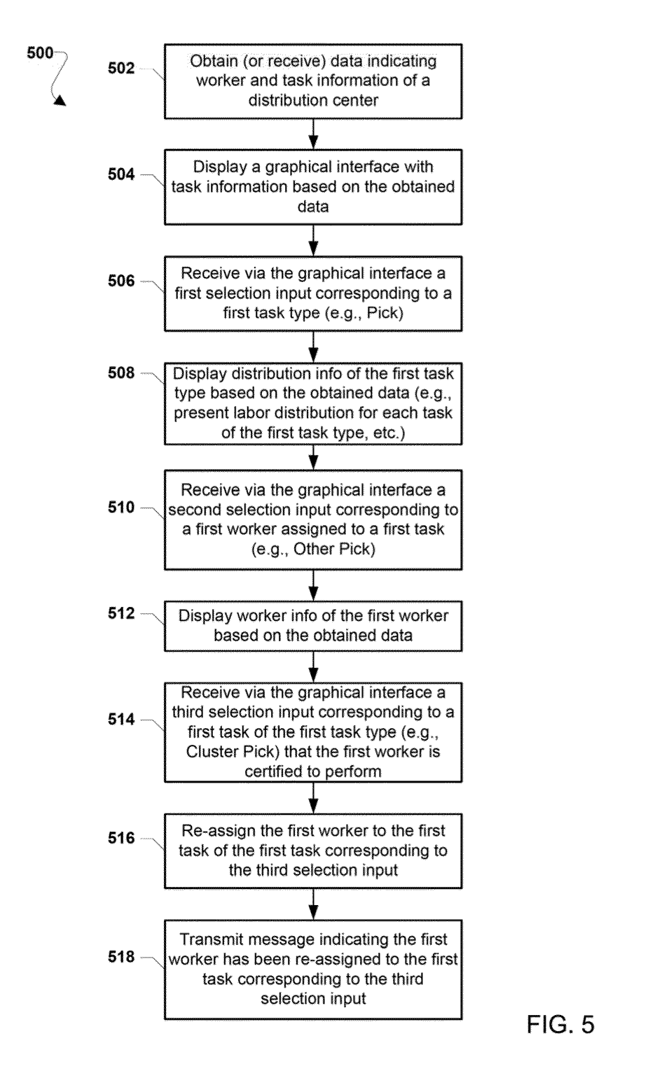

FIGS. 4 and 5 illustrate embodiment methods related to determining and displaying state information for tasks performed within a distribution center based on various status and/or activity information. The following descriptions indicate that a computing device may be configured to perform the operations of the embodiment methods. For example, a server processor may perform operations to execute software, instructions, threads, and/or applications to evaluate stored data to determine the current state for tasks within a distribution center for a certain time of day. However, those skilled in the art should appreciate that any processor(s) of any computing device(s) may be configured to perform any combination of the operations. For example, a server, a remote computing device and/or a laptop computing device connected to a local area network within a distribution center may be configured to perform any of the embodiment methods 400 or 500. Further, although the methods 400, 500 are described below to relate to labor distribution as indicated by states of various tasks, it should be appreciated that any state information may be used to determine the adequacy of labor distribution. For example, a computing device may evaluate state indicators associated with particular zones of a distribution center to determine whether tasks within the zones are adequately staffed, etc. As another example, a computing device may evaluate state indicators of task types (e.g., summaries of individual tasks in one or more zones of the distribution center, etc.) to determine whether labor in the distribution center is adequately distributed.

FIG. 4 illustrates an embodiment method 400 for a computing device to determine states of tasks performed within a distribution center based on task workloads and worker assignments. As described above, states may represent how well workers are distributed (or assigned) to tasks of the distribution center (e.g., Pick, Audit, Cluster Pick, Put away, etc.), and thus states may indicate whether and/or when workers need to be re-assigned to better apportion the labor force within a distribution center. For example, when all tasks (or task types) of a distribution center have an adequate state (e.g., 0% overstaffed, 0% understaffed, etc.), no re-assignments may be needed as workers are well distributed for the current amount of work to be done throughout the distribution center. As another example, when one or more tasks have inadequate states, management may need to re-assign workers to improve the capabilities of the inadequately staffed tasks to handle their respective workloads.

In block 402 the processor of the computing device may obtain activity information of a distribution center. Such activity information may include information indicating the current workloads for various tasks (or task types) in various zones (e.g., a delivery schedule), expected workloads over a period, order lists, the types of tasks that are preformed in particular zones (e.g., pick, audit, etc.), priorities of zones and/or tasks within zones (e.g., a rank or importance value for each task within each zone, a rank or importance value for each zone in the distribution center, etc.), and historical data that represents trends of workloads for tasks, task types, and/or in various zones. For example, the activity information may include delivery schedules for items that are to arrive at a distribution center and accordingly may need to be processed by workers (e.g., unpack, sort, shelve, etc.). As another example, the activity information may include lists of orders for merchandise within the distribution center that may need to be processed and shipped in response to customers submitting requests. As another example, the activity information may include data that indicates average, maximum, or minimum workloads for specific tasks, task types, and/or individual zones within a distribution center over the last day, week, month, year, etc. In an embodiment, the activity information may be obtained from a demand scheduler module running on the computing device or running of a separate computing device connected to the computing device and outputting activity information.

In block 404 the processor of the computing device may obtain status information of workers in the distribution center. The status information may include various data indicating the employment status (e.g., new hire, years employed, fired, hiatus, suspended, disabled, etc.), current schedule or availability (e.g., day shift, 9AM-5PM, currently on a break, etc.), credentials (e.g., licenses, awards, certifications, training, skills, etc.), current location (e.g., in a certain zone, on a loading dock, in an office, off distribution center premises, etc.), historical data (e.g., previous assignments, efficiency ratings, typical vacation and/or break times, etc.), contact information (e.g., phone number, home address, email address, etc.), and currently assigned tasks (e.g., assigned to pick, put away, indirect, etc.). For example, the status information may indicate the current task assignments for all workers within a distribution center at the current time. As another example, the status information may include data that indicates a set of workers who are capable of carrying out multiple tasks within the various zones of a distribution center.

In block 406 the processor of the computing device may identify the current workload for each task performed within the distribution center based on the obtained activity information of the distribution center. In other words, the computing device may identify a prescribed or required number of workers to adequately staff each task for a given period. The computing device may perform various evaluations, calculations, and/or analysis of the obtained activity information to determine an amount of manpower, skills, time, and other labor-related resources that may be required for each task based on the current magnitude and amount work that is expected to be processed over a current time period (e.g., a shift, an hour, fifteen minutes, etc.). For example, the computing device may analyze the type and number of shipping orders that need to be completed in a zone to determine how many workers should be assigned to tasks to process these orders.

In block 408 the processor of the computing device may identify the current number of active workers for each task based on the obtained status information of workers. For example, the computing device may perform a query or look-up operations on a data table of the obtained status information to find the workers currently assigned to particular tasks performed within various zones within the distribution center. In an embodiment, the identified current number of active workers may include projected numbers based on trend data within the status information. For example, the computing device may estimate that when a shift change occurs, a certain number of workers may start or stop performing specific tasks.

In block 410 the processor of the computing device may determine the state of each task based on the identified current workloads and numbers of active workers. In other words, the computing device may determine the states of the tasks by comparing the labor determined to be needed for the various tasks to the labor that is actually available (or assigned) to the tasks to determine whether the labor is within an acceptable threshold of the labor need. For example, the computing device may determine that the state of a first task (e.g., Cluster pick) is inadequate (or inadequately staffed) as the estimated current workload for the first task is higher than the number of active workers assigned to perform the first task. As described above, the computing device may utilize user defined acceptable thresholds when determining the state of tasks. For example, a task may be determined to be adequately staffed when the number of active workers assigned to the task is within a predefined number of workers of the identified current workload. In various embodiments, states may be binary (e.g., adequate/inadequate, good/bad, acceptable/failing, etc.), or may include various scaled or gradated (i.e., values on a gradation). For example, the computing device may determine the state of a task to correspond to a number on a scale from one to ten, with ten being the most adequate and one being the least adequate.

In block 412 the processor of the computing device may assign a state indicator (e.g., a color, a pattern, etc.) to each of the tasks based on their respective determined states. For example, an assigned state indicator(s) may be colors, such that green may indicate an adequate amount of workers assigned to a task, yellow may indicate a marginally-adequate amount of workers assigned to the task, and red may indicate an inadequate amount of workers assigned to the task. It should be appreciated that any graphics, imagery, words, sounds, symbols, and/or signs that may be recognizable and known to users of the computing device may be utilized as state indicators. In block 414, the processor of the computing device may store data representing the determined states and assigned state indicators of the tasks. In various embodiments, the computing device may update data records within a database or other storage structure or coupled device. Additionally, the computing device may perform operations to store historical information, such as by archiving previously determined states for use in identifying trending information.

In block 416 the processor of the computing device may display via a graphical interface the stored data (or a portion of the stored data) representing the determined states and/or the assigned state indicators of the tasks. For example, the computing device may render on a touchscreen, connected LCD screen, or other display unit the assigned state indicators for each task performed in the distribution center. In an embodiment, when the computing device is a server, the stored data may not be displayed, but may be transmitted to another computing device for display. Alternatively, the computing device may generate metadata, such as formatting information, images, or text language, for another device to display the stored data. For example, when the computing device is a web server (or provides data for an associated web server), the server may generate HTML code for use by a browser in rendering the state indicators of each of the tasks performed in the distribution center. In an embodiment, the processor of the computing device may display state date in a graphical user interface in the manner described above with reference to FIGS. 2A and 2B.

In determination block 418 the processor of the computing device may determine whether any states have been below an acceptable threshold for longer than a set time period. As discussed above, the set time period and acceptable threshold may be user configurable values set by a user, such as a distribution center manager. As an example, the set time period may be fifteen minutes and the acceptable threshold may be ten percent under staffed. The computing device may track the time in the current state for each task performed within the distribution center and may compare the time a state of a task has been below the acceptable threshold to a the set time period to determine whether the state has been below the acceptable threshold for longer than the set time period. If a zone has been below the acceptable threshold for longer than the set time period (i.e., determination block 418=“Yes”), in block 420 the processor of the computing device may display via a graphical interface a pulsed indication of the stored data representing the determined states and/or assigned state indicators of the tasks. As discussed above, the state indicator of a task may be flashed or otherwise adjusted to indicate the state of the task has been below the acceptable threshold for longer than the set time period. In this manner, tasks that may fall under the acceptable threshold for more than a temporary period may be easily and efficiently identified to the distribution center management. Upon displaying the pulsed indication in block 420 and/or if a task has not been below the acceptable threshold for longer than the set time period (i.e., determination block 418 =“No”), in block 402 the processor of the computing device may continue to obtain activity information of a distribution center. In this manner, the operations of method 400 may be performed continuously to determine and display indications of the current states of the tasks performed within the distribution center.

FIG. 5 illustrates an embodiment method 500 for a computing device to receive selection inputs to re-assign workers to different tasks performed within a distribution center. In various embodiments, the worker may be re-assigned to a different task that is within the same or a different zone of the distribution center, and/or the different task may or may not be of a different task type. For example, the computing device may receive selection inputs to assign a worker from a “Cluster pick” task in a ‘Pick’ general task type to a “Discrete pick” task also within the ‘Pick’ task type. As another example, the computing device may receive selection inputs to assign a worker from a “Cluster pick” task in a first zone to the “Cluster” pick task in a second zone.

In block 502 the processor of the computing device may obtain (or receive) data indicating worker and zone information of a distribution center, such as data that indicates the various states and pulse values associated with specific tasks, the various tasks currently assigned to various workers within the distribution center, the identifies of workers within various zones, data indicating the tasks workers are capable of being re-assigned to perform, etc. In other words, the obtained data may include current (e.g., up-to-date) activity information of tasks (or task types or zones, etc.) and worker status information as described above with reference to FIG. 4. In an embodiment, the obtained data may be obtained (or received) from a remote computing device (e.g., a server, etc.) or alternatively may be retrieved from local storage (e.g., a data source coupled to the computing device, etc.).

In block 504 the processor of the computing device may display a graphical interface with task information based on the obtained data. For example, the computing device may render on a connected display unit (e.g., a touchscreen, an LCD display, etc.) the graphical interface including graphical elements for each task type (or specific task), such as described above with reference to FIGS. 2A-2B and FIGS. 3A-3B. As described above, the task information may be represented by or otherwise include state indicators, such as graphical elements for each of the tasks performed in the distribution center that are colored, sized, or formatted to represent the current labor adequacy for each task (e.g., how well staffed each task is). In an embodiment, the state indicators (or associated graphical elements) may be configured to pulse based on pulse values indicated in the obtained data. For example, an interactive graphical element corresponding to a certain task may be configured to be rendered in a strobe-like or flashing manner to indicate the certain task has been understaffed for a period exceeding a predefined time period.

In block 506 the processor of the computing device may receive via the graphical interface a first selection input corresponding to a first task type. For example, the computing device may detect a touch input (e.g., a tap, a poke, a press, a swipe, etc.) on a touchscreen that coincides with a rendered graphical element for a general type of task that is performed within the distribution center (e.g., Pick). FIG. 3A illustrates an example selection input on a graphical element corresponding to a task type.

In response to the received first selection input, the processor of the computing device may display via the graphical interface distribution information of the first task type based on the obtained data in block 508. For example, the computing device may render a window or panel within the graphical interface that indicates the specific tasks of the first task type that are performed within the distribution center, as well as individual workers assigned to the various specific tasks, and estimates of the adequacy of the current workers for individual tasks. FIG. 3B illustrates an example display of labor distribution information within a graphical interface.

In block 510 the processor of the computing device may receive via the graphical interface a second selection input corresponding to a first worker assigned to a first task. For example, the computing device may detect a mouse cursor click or touchscreen input within the rendered area of a graphical element associated with a first worker currently assigned to an ‘other’ pick task included within a “Pick” task type. FIG. 3C illustrates an example selection input on a graphical element corresponding to a worker.

In response to the received second selection input, the processor of the computing device may display via the graphical interface worker information of the first worker based on the obtained data in block 512. For example, the computing device may render a window that presents information indicating the first worker's currently assigned task and one or more other tasks the first worker is certified or trained to perform in the various zones of the distribution center. FIG. 3D illustrates an example display of worker information within a graphical interface.

In block 514 the processor of the computing device may receive a third selection input corresponding to a second task the first worker is certified (or trained) to perform. As described above with reference to FIG. 3D, the computing device may render interactive GUI elements (e.g., buttons) that may be linked to routines, applications, or other operations that may result in re-assignment of the first worker to different tasks. For example, the computing device may render a “re-assign” GUI button next to each task in the worker information displayed via the graphical interface, where each GUI button may be configured to update a database, transmit a message, or otherwise perform operations to change the first worker's current task assignment. As another example, drag and drop actions with icons or other elements of the user interface may be also be configured to update a database, transmit a message, or otherwise perform operations to change the first worker's current task assignment. In particular, in block 516, the processor of the computing device may re-assign the first worker to the second task corresponding to the third selection input, such as by adjusting the obtained data to indicate the first worker has been re-assigned to the second task corresponding to the third selection input. For example, the computing device may change the value of a data field within a database record to indicate a new task assignment for the first worker (e.g., re-assigned from “other pick” task to a “cluster pick” task, etc.). In an embodiment, the adjusted data may be a portion of a packet that may be relayed back to a server, such as a web server or server configured to maintain worker status and/or activity information of the distribution center.

In block 518, the processor of the computing device may transmit a message indicating the first worker has been re-assigned to the second task corresponding to the third selection input. For example, the computing device may transmit a message to a server or alternatively may transmit a notification message to a computing device used by distribution center personnel, a display unit within the distribution center, and/or a personal device of the first worker (e.g., “You've been re-assigned to Pick,” etc.).

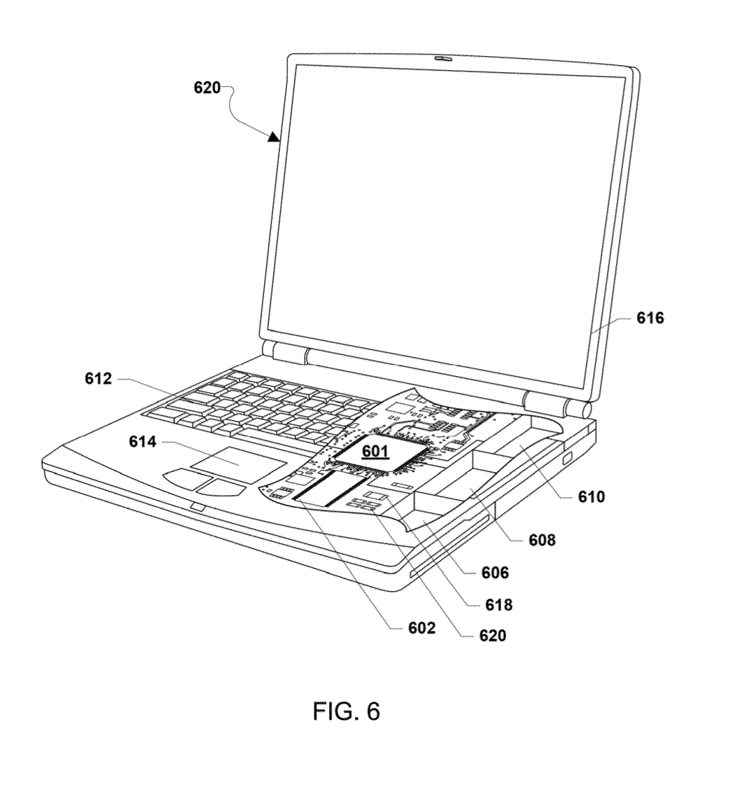

Various forms of computing devices, including personal computers and laptop computers, may be used to implementing the various embodiments. Such computing devices typically include the components illustrated in FIG. 6 which illustrates an example laptop computing device 620. Many laptop computers include a touch pad touch surface 614 that serves as the computer's pointing device, and thus may receive drag, scroll, and flick gestures similar to those implemented on mobile computing devices equipped with a touch screen display and described above. Such a laptop computing device 620 generally includes a processor 601 coupled to volatile internal memory 602 and a large capacity nonvolatile memory, such as a disk drive 606. The laptop computing device 620 may also include a compact disc (CD) and/or DVD drive 608 coupled to the processor 601. The laptop computing device 620 may also include a number of connector ports 610 coupled to the processor 601 for establishing data connections or receiving external memory devices, such as a network connection circuit for coupling the processor 601 to a network. The laptop computing device 620 may have one or more radio signal transceivers 618 (e.g., Peanut®, Bluetooth®, Zigbee®, WiFi, RF radio) and antennas 620 for sending and receiving wireless signals as described herein. The transceivers 618 and antennas 620 may be used with the above-mentioned circuitry to implement the various wireless transmission protocol stacks/interfaces. In a laptop or notebook configuration, the computer housing may include the touch pad 614, the keyboard 612, and the display 616 all coupled to the processor 601. Other configurations of the computing device may include a computer mouse or trackball coupled to the processor (e.g., via a USB input) as are well known, which may also be used in conjunction with the various embodiments.

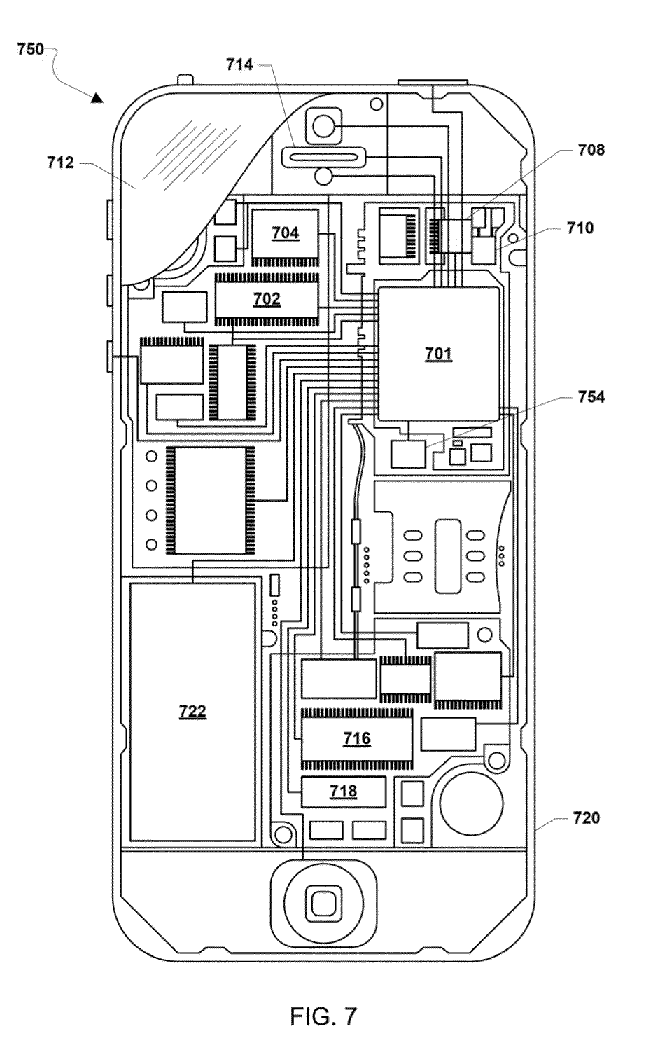

FIG. 7 illustrates an embodiment wireless computing device 750 suitable for use in various embodiments. The wireless computing device 750 may be a personal computing device worn or carried by a worker in a distribution center, such as a wireless computing device connected to headphones worn by the worker as part of a voice directed picking system. The wireless computing device 750 may include a processor 701 coupled to a touchscreen controller 704 and an internal memory 702. The processor 701 may be one or more multicore ICs designated for general or specific processing tasks. The internal memory 702 may be volatile or non-volatile memory, and may also be secure and/or encrypted memory, or unsecure and/or unencrypted memory, or any combination thereof The touchscreen controller 704 and the processor 701 may also be coupled to a touchscreen panel 712, such as a resistive-sensing touchscreen, capacitive-sensing touchscreen, infrared sensing touchscreen, etc. The wireless computing device 750 may have one or more radio signal transceivers 708 (e.g., Peanut®, Bluetooth®, Zigbee®, Wi-Fi, RF radio) and antennae 710, for sending and receiving, coupled to each other and/or to the processor 701. The transceivers 708 and antennae 710 may be used with the above-mentioned circuitry to implement the various wireless transmission protocol stacks and interfaces. The wireless computing device 750 may include a wireless modem chip 716 that enables communication via a wireless network, such as a cellular network, and is coupled to the processor 701. The wireless computing device 750 may include a peripheral device connection interface 718 coupled to the processor 701. The peripheral device connection interface 718 may be singularly configured to accept one type of connection, or multiply configured to accept various types of physical and communication connections, common or proprietary, such as USB, FireWire, Thunderbolt, PCIe, and/or audio connections. The peripheral device connection interface 718 may also be coupled to a similarly configured peripheral device connection port, such as an audio jack enabling audio outputs to a connected headset and/or audio inputs from a connected microphone. The wireless computing device 750 may also include speakers 714 for providing audio outputs. The wireless computing device 750 may also include a housing 720, constructed of a plastic, metal, or a combination of materials, for containing all or some of the components discussed herein. The wireless computing device 750 may include a power source 722 coupled to the processor 701, such as a disposable or rechargeable battery. The rechargeable battery may also be coupled to the peripheral device connection port to receive a charging current from a source external to the wireless computing device 750. Additionally, the wireless computing device 750 may include a GPS receiver chip 754 coupled to the processor 701.

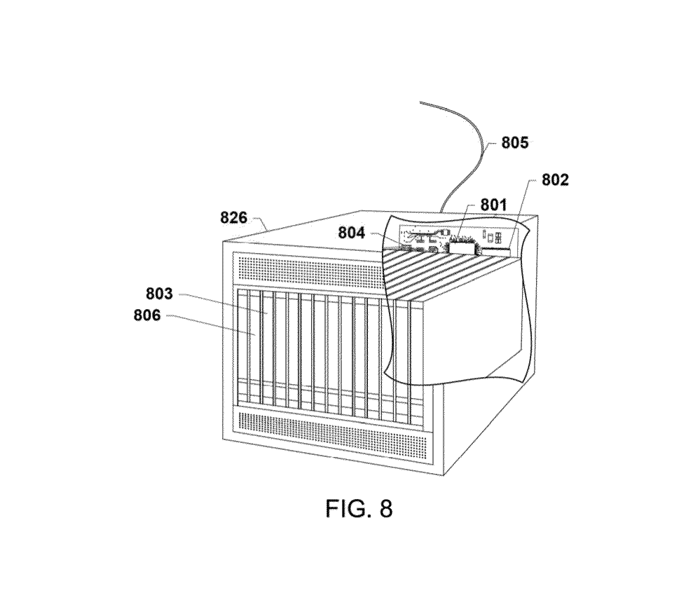

The various embodiments may be implemented on any of a variety of commercially available server devices, such as a server 826 illustrated in FIG. 8. Such a server 826 typically includes a processor 801 coupled to volatile memory 802 and a large capacity nonvolatile memory, such as a disk drive 803. The server 826 may also include a floppy disc drive, compact disc (CD) or DVD disc drive 806 coupled to the processor 801. The server 826 may also include network access ports 804 coupled to the processor 801 for establishing data connections with a network 805, such as a local area network coupled to other broadcast system computers and servers.

The processors 601, 701, and 801 may be any programmable microprocessor, microcomputer or multiple processor chip or chips that can be configured by software instructions (applications) to perform a variety of functions, including the functions of the various embodiments described above. In the various devices, multiple processors may be provided, such as one processor dedicated to wireless communication functions and one processor dedicated to running other applications. Typically, software applications may be stored in the internal memory 602, 702, and 802 before they are accessed and loaded into the processors 601, 701, and 801. The processors 601, 701, and 801 may include internal memory sufficient to store the application software instructions. In many devices the internal memory may be a volatile or nonvolatile memory, such as flash memory, or a mixture of both. For the purposes of this description, a general reference to memory refers to memory accessible by the processors 601, 701, and 801 including internal memory or removable memory plugged into the various devices and memory within the processors 601, 701, and 801.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), a graphics processing unit (GPU) an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof If implemented in software, the functions may be stored on or transmitted over as one or more instructions or code on a non-transitory computer-readable or server-readable medium or a non-transitory processor-readable storage medium. The steps of a method or algorithm disclosed herein may be embodied in a processor-executable software module which may reside on a tangible, non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method, comprising:
identifying, in a computing device, a current workload for a first task performed within a distribution center based on activity information of the distribution center;
identifying, in the computing device, a current number of active workers assigned to the first task based on status information of workers of the distribution center;
determining, in the computing device, a state of the first task that indicates an adequacy of labor for the first task based on the identified current workload of the first task and the identified current number of active workers assigned to the first task;
assigning, in the computing device, a state indicator to the first task based on the determined state; and
displaying the assigned state indicator of the first task.

2. The method of claim 1, further comprising:
determining, in the computing device, whether the state of the first task has been below an acceptable threshold for longer than a set time period; and
pulsing the displayed assigned state indicator of the first task in response to determining the state of the first task has been below the acceptable threshold for longer than the set time period.

3. The method of claim 2, wherein the acceptable threshold and the set time period are user configurable values.

4. The method of claim 1, wherein the activity information is one or more of a delivery schedule, an order list, an expected workload for the first task, types of tasks preformed in a zone, a priority, and historical data related to the first task.

5. The method of claim 1, wherein the status information is one or more of an employment status, a current schedule, a certification, a current location, historical data related to the workers, and a currently assigned task.

6. The method of claim 1, wherein the assigned state indicator is a color.

7. The method of claim 1, further comprising:
identifying, in the computing device, a plurality of tasks of a first type based on the activity information of the distribution center, wherein the first task is one of the plurality of tasks of the first type;
identifying, in the computing device, a current workload for the plurality of tasks of the first type based on the activity information of the distribution center;
identifying, in the computing device, a plurality of individual workers currently assigned to one of the plurality of tasks of the first type based on the status information of the workers of the distribution center; and
comparing, in the computing device, the identified current workload for the plurality of tasks of the first type with the identified plurality of individual workers currently assigned to one of the plurality of tasks of the first type to determine an adequacy of labor for the plurality of tasks of the first type; and
determining, in the computing device, a state of the plurality of tasks of the first type that indicates the adequacy of labor for the plurality of tasks of the first type based on the identified current workload of the plurality of tasks of the first type and the identified current number of active workers assigned to one of the plurality of tasks of the first type.

8. The method of claim 7, further comprising analyzing, in the computing device, the status information of the identified plurality of individual workers currently assigned to the plurality of tasks of the first type to determine whether any of the plurality of individual workers are capable of being re-assigned to improve the adequacy of labor for the plurality of tasks of the first type.

9. The method of claim 7, further comprising:
receiving via a graphical interface a first selection input corresponding to a first interactive element;
displaying labor distribution information of the plurality of tasks of the first type in response to receiving the first selection input;
receiving via the graphical interface a second selection input corresponding to a second interactive element, wherein the second interactive element corresponds to a first worker assigned to the first task of the plurality of tasks of the first type;
displaying worker information related to the first worker based on the status information of the workers of the distribution center in response to receiving the second selection input;
receiving via the graphical interface a third selection input corresponding to a third interactive element, wherein the third interactive element corresponds to a second task of the plurality of tasks of the first type the first worker is certified to perform;
re-assigning the first worker to the second task in response to receiving the third selection input; and
transmitting a message indicating the second task to the first worker in response to re-assigning the first worker to the second task.

10. A computing device, comprising:
a memory;
a display; and
a processor coupled to the memory and the display, wherein the processor is configured with processor-executable instructions to perform operations comprising:
identifying a current workload for a first task performed within a distribution center based on activity information of the distribution center;
identifying a current number of active workers assigned to the first task based on status information of workers of the distribution center;
determining a state of the first task that indicates an adequacy of labor for the first task based on the identified current workload of the first task and the identified current number of active workers assigned to the first task;
assigning a state indicator to the first task based on the determined state; and
displaying the assigned state indicator of the first task.

11. The computing device of claim 10, wherein the processor is configured with processor-executable instructions to perform operations further comprising:
determining whether the state of the first task has been below an acceptable threshold for longer than a set time period; and
pulsing the displayed assigned state indicator of the first task in response to determining the state of the first task has been below the acceptable threshold for longer than the set time period.

12. The computing device of claim 11, wherein the processor is configured with processor-executable instructions to perform operations such that the acceptable threshold and the set time period are user configurable values.

13. The computing device of claim 10, wherein the processor is configured with processor-executable instructions to perform operations such that the activity information is one or more of a delivery schedule, an order list, an expected workload for the first task, types of tasks preformed in a zone, a priority, and historical data related to the first task.

14. The computing device of claim 10, wherein the processor is configured with processor-executable instructions to perform operations such that the status information is one or more of an employment status, a current schedule, a certification, a current location, historical data related to the workers, and a currently assigned task.

15. The computing device of claim 10, wherein the processor is configured with processor-executable instructions to perform operations such that the assigned state indicator is a color.

16. The computing device of claim 10, wherein the processor is configured with processor-executable instructions to perform operations further comprising:
identifying a plurality of tasks of a first type based on the activity information of the distribution center, wherein the first task is one of the plurality of tasks of the first type;
identifying a current workload for the plurality of tasks of the first type based on the activity information of the distribution center;
identifying a plurality of individual workers currently assigned to one of the plurality of tasks of the first type based on the status information of the workers of the distribution center; and
comparing the identified current workload for the plurality of tasks of the first type with the identified plurality of individual workers currently assigned to one of the plurality of tasks of the first type to determine an adequacy of labor for the plurality of tasks of the first type; and
determining a state of the plurality of tasks of the first type that indicates the adequacy of labor for the plurality of tasks of the first type based on the identified current workload of the plurality of tasks of the first type and the identified current number of active workers assigned to one of the plurality of tasks of the first type.

17. The computing device of claim 16, wherein the processor is configured with processor-executable instructions to perform operations further comprising analyzing the status information of the identified plurality of individual workers currently assigned to the plurality of tasks of the first type to determine whether any of the plurality of individual workers are capable of being re-assigned to improve the adequacy of labor for the plurality of tasks of the first type.

18. The computing device of claim 16, wherein the processor is configured with processor-executable instructions to perform operations further comprising:
receiving via a graphical interface a first selection input corresponding to a first interactive element;
displaying labor distribution information of the plurality of tasks of the first type in response to receiving the first selection input;
receiving via the graphical interface a second selection input corresponding to a second interactive element, wherein the second interactive element corresponds to a first worker assigned to the first task of the plurality of tasks of the first type;
displaying worker information related to the first worker based on the status information of the workers of the distribution center in response to receiving the second selection input;
receiving via the graphical interface a third selection input corresponding to a third interactive element, wherein the third interactive element corresponds to a second task of the plurality of tasks of the first type the first worker is certified to perform;
re-assigning the first worker to the second task in response to receiving the third selection input; and
transmitting a message indicating the second task to the first worker in response to re-assigning the first worker to the second task.

19. A non-transitory processor-readable storage medium having stored thereon processor-executable instructions configured to cause a processor of a computing device to perform operations comprising:
identifying a current workload for a first task performed within a distribution center based on activity information of the distribution center;
identifying a current number of active workers assigned to the first task based on status information of workers of the distribution center;
determining a state of the first task that indicates an adequacy of labor for the first task based on the identified current workload of the first task and the identified current number of active workers assigned to the first task;
assigning a state indicator to the first task based on the determined state; and
displaying the assigned state indicator of the first task.

20. The non-transitory processor-readable storage medium of claim 19, wherein the stored processor-executable instructions are configured to cause the processor to perform operations further comprising:
determining whether the state of the first task has been below an acceptable threshold for longer than a set time period; and
pulsing the displayed assigned state indicator of the first task in response to determining the state of the first task has been below the acceptable threshold for longer than the set time period.

21. The non-transitory processor-readable storage medium of claim 20, wherein the stored processor-executable instructions are configured to cause the processor to perform operations such that the acceptable threshold and the set time period are user configurable values.

22. The non-transitory processor-readable storage medium of claim 19, wherein the stored processor-executable instructions are configured to cause the processor to perform operations such that the activity information is one or more of a delivery schedule, an order list, an expected workload for the first task, types of tasks preformed in a zone, a priority, and historical data related to the first task.

23. The non-transitory processor-readable storage medium of claim 19, wherein the stored processor-executable instructions are configured to cause the processor to perform operations such that the status information is one or more of an employment status, a current schedule, a certification, a current location, historical data related to the workers, and a currently assigned task.

24. The non-transitory processor-readable storage medium of claim 19, wherein the stored processor-executable instructions are configured to cause the processor to perform operations such that the assigned state indicator is a color.

25. The non-transitory processor-readable storage medium of claim 19, wherein the stored processor-executable instructions are configured to cause the processor to perform operations further comprising:
identifying a plurality of tasks of a first type based on the activity information of the distribution center, wherein the first task is one of the plurality of tasks of the first type;
identifying a current workload for the plurality of tasks of the first type based on the activity information of the distribution center;
identifying a plurality of individual workers currently assigned to one of the plurality of tasks of the first type based on the status information of the workers of the distribution center; and
comparing the identified current workload for in the plurality of tasks of the first type with the identified plurality of individual workers currently assigned to one of the plurality of tasks of the first type to determine an adequacy of labor for the plurality of tasks of the first type; and
determining a state of the plurality of tasks of the first type that indicates the adequacy of labor for the plurality of tasks of the first type based on the identified current workload of the plurality of tasks of the first type and the identified current number of active workers assigned to one of the plurality of tasks of the first type.

26. The non-transitory processor-readable storage medium of claim 25, wherein the stored processor-executable instructions are configured to cause the processor to perform operations further analyzing the status information of the identified plurality of individual workers currently assigned to the plurality of tasks of the first type to determine whether any of the plurality of individual workers are capable of being re-assigned to improve the adequacy of labor for the plurality of tasks of the first type.

27. The non-transitory processor-readable storage medium of claim 25, wherein the stored processor-executable instructions are configured to cause the processor to perform operations further comprising:
receiving via a graphical interface a first selection input corresponding to a first interactive element;
displaying labor distribution information of the plurality of tasks of the first type in response to receiving the first selection input;
receiving via the graphical interface a second selection input corresponding to a second interactive element, wherein the second interactive element corresponds to a first worker assigned to the first task of the plurality of tasks of the first type;
displaying worker information related to the first worker based on the status information of the workers of the distribution center in response to receiving the second selection input;
receiving via the graphical interface a third selection input corresponding to a third interactive element, wherein the third interactive element corresponds to a second task of the plurality of tasks of the first type the first worker is certified to perform;
re-assigning the first worker to the second task in response to receiving the third selection input; and
transmitting a message indicating the second task to the first worker in response to re-assigning the first worker to the second task.
